(19) United States
(12) Patent Application Publication
(10) Pub. No.: US 2006/0237135 A1
(43) Pub. Date: Oct. 26, 2006

(54) Olefin series material and method of manufacturing the same

(75) Inventors: Eiji Sakaguchi, Yoshinogun (JP); Junichi Takeda, Ikomagun (JP); Hiroaki Ishii, Tenrishi (JP); Takahiro Shibayama, Osaka (JP)

Correspondence Address: ARMSTRONG, KRATZ, QUINTOS, HANSON & BROOKS, LLP, 1725 K STREET, NW, SUITE 1000, WASHINGTON, DC, 20006, US

(73) Assignee: SUMINOE TEXTILE CO., LTD., Osakashi (JP)

(21) Appl. No.: 11/401,442

(22) Filed: Apr. 11, 2006

(30) Foreign Application Priority Data
Apr. 15, 2005 (JP) 2005-117751

(51) Int. Cl. B32B 27/40; B32B 27/32

(52) U.S. Cl. 156/334; 428/523; 428/521; 428/423.1; 428/340; 428/337; 428/339; 428/215

(57) ABSTRACT

In an olefin series flooring material according to the present invention, a printed layer 4 containing synthetic resin is laminated on a lower surface of a surface resin layer 2 containing olefin series resin, and a base material layer 3 containing olefin series resin is integrally laminated on a lower surface of the printed layer 4 via an adhesive layer 5. The adhesive layer 5 contains carboxylic acid denaturation propylene-1-butene copolymer resin and carboxylic acid denaturation propylene-ethylene-1-butene copolymer resin, and a mass ratio of the carboxylic acid denaturation propylene-1-butene copolymer resin/the carboxylic acid denaturation propylene-ethylene-1-butene copolymer resin falls within the range of 55/45 to 95/5. According to this olefin series flooring material, sufficient adhesive strength for the printed layer can be obtained.

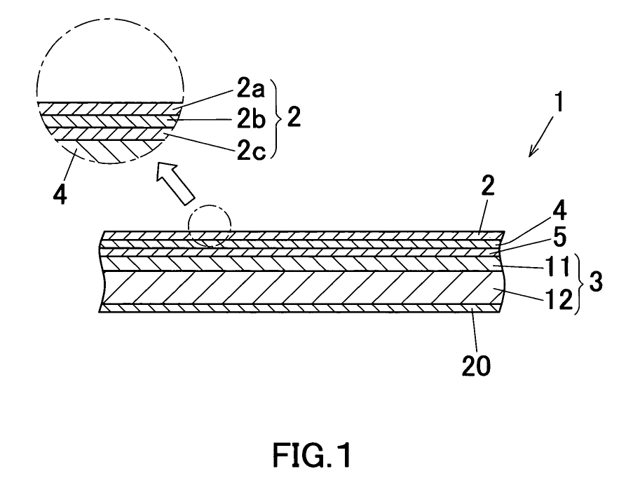

This application claims priority to Japanese Patent Application No. 2005-117751 filed on Apr. 15, 2005, the entire disclosure of which is incorporated herein by reference in its entirety.

### BACKGROUND OF THE INVENTION

1. Field of the Invention

The present invention relates to an olefin series flooring material to be used as a flooring material for architectural structures, such as, e.g., buildings, condominiums, houses and commercial facilities or a flooring material for vehicles, such as, e.g., trains or buses.

2. Prior Art

Conventionally, as a flooring material for use in architectural structures, such as, e.g., buildings, condominiums, houses or commercial facilities or a floor material for use in vehicles, such as, e.g., trains or buses, a flooring material made of polyvinyl chloride (PVC) resin had been widely used. However, a PVC flooring material generates poisonous gases, such as, e.g., hydrogen chloride, together with a large amount of smoke at the time of burning, which raises disaster problems. Furthermore, such flooring material also causes environmental pollution at the time of the incineration disposal processing. Under the circumstances, in recent years, olefin series flooring materials have become popular.

On such a flooring material, designs, such as, e.g., figures, patterns or characters, are usually imparted by printing, etc. For example, an olefin series flooring material made of a laminated sheet in which a base material layer made of polyolefin series resin, a printed layer, and a surface layer made of polyolefin series resin are laminated in this order and glued by reactive hot melt adhesive therebteween is known (see Patent Document 1).

Also known is an olefin series flooring material in which a patterned layer and a transparent resin layer are laminated in this order on a colored base material sheet made of readily-adhesive olefin series thermoplastic resin (see Patent Document 2).

Patent Document 1: Japanese Unexamined Laid-open Patent Publication No. 2000-229390

Patent Document 2: Japanese Unexamined Laid-open Patent Publication No. H11-147293

However, the olefin series flooring materials as disclosed in Patent Documents Nos. 1 and 2 had such problems as unstable adhesive strength and/or insufficient adhesive strength. Especially in cases where printing ink for forming a printed layer containing urethane series resin is used, interlaminar adhesive strength became insufficient.

The present invention was made in view of the aforementioned technical background, and aims to provide an olefin series flooring material capable of obtaining sufficient adhesive strength for securing a printed layer.

Other objects of the present invention will be apparent from the following embodiments.

### SUMMARY OF THE INVENTION

In order to attain the aforementioned objects, the present invention provides the following means.

[1] An olefin series flooring material, comprising:
a surface resin layer containing olefin series resin;
a printed layer laminated on a lower surface of the surface resin layer; and
a base material layer containing olefin series resin integrally laminated on a lower surface of the printed layer via an adhesive layer,
wherein the adhesive layer contains carboxylic acid denaturation propylene-1-butene copolymer resin and carboxylic acid denaturation propylene-ethylene-1-butene copolymer resin, and
wherein a mass ratio of the carboxylic acid denaturation propylene-1-butene copolymer resin/the carboxylic acid denaturation propylene-ethylene-1-butene copolymer resin falls within the range of 55/45 to 95/5.

[2] The olefin series flooring material as recited in the aforementioned Item [1], wherein maleic acid denaturation propylene-1-butene copolymer resin is used as the carboxylic acid denaturation propylene-1-butene copolymer resin, and wherein maleic acid denaturation propylene-ethylene-1-butene copolymer resin is used as the carboxylic acid denaturation propylene-ethylene-1-butene copolymer resin.

[3] The olefin series flooring material as recited in the aforementioned Item 1 or 2, wherein the printed layer contains urethane series resin.

[4] The olefin series flooring material as recited in any one of the aforementioned Items 1 to 3, wherein an amount of the adhesive layer is 1 to 10 g/m².

[5] The olefin series flooring material as recited in any one of the aforementioned Items 1 to 4, wherein the adhesive layer is formed by printing.

[6] The olefin series flooring material as recited in any one of the aforementioned Items 1 to 5, wherein a mass ratio of the carboxylic acid denaturation propylene-1-butene copolymer resin/the carboxylic acid denaturation propylene-ethylene-1-butene copolymer resin falls within the range of 60/40 to 90/10.

[7] A method of manufacturing an olefin series flooring material, comprising:
a step of forming a printed layer on a lower surface of a surface resin layer containing olefin series resin by printing using printing ink containing synthetic resin;
a step of applying a mixture in which carboxylic acid denaturation propylene-1-butene copolymer resin/carboxylic acid denaturation propylene-ethylene-1-butene copolymer resin are mixed in a mass ratio of 55/45 to 95/5 on a lower surface of the printed layer;
a step of superimposing a base material layer containing olefin series resin on a mixture applied surface of the printed layer and bonding them to thereby obtain a laminated member; and
a step of heating the laminated member.

[8] The method of manufacturing an olefin series flooring material as recited in the aforementioned Item 7, wherein the laminated member is heated at a temperature of 80 to 120° C.

According to the invention as recited in the aforementioned Item [1], as the is adhesive for bonding the printed layer formed on the lower surface of the surface resin layer and the olefin series resin base material layer, the adhesive in which carboxylic acid denaturation propylene-1-butene copolymer resin and carboxylic acid denaturation propylene-ethylene-1-butene copolymer resin are contained and the mass ratio of the carboxylic acid denaturation propylene-1-butene copolymer resin/carboxylic acid denaturation propylene-ethylene-1-butene copolymer resin falls within the range of 55/45 to 95/5, is used. Therefore, the printed layer formed on the lower surface of the surface resin layer and the base material layer can be integrally bonded with sufficient adhesive strength. Accordingly, an olefin series flooring material excellent in adhesion durability which hardly causes delamination for a long period of time can be provided.

According to the invention as recited in the aforementioned Item [2], since the carboxylic acid denaturation in both copolymer resins is maleic acid denaturation, the adhesive strength between the printed layer and the base material layer can be further increased.

According to the invention as recited in the aforementioned Item [3], although the printed layer contains urethane series resin, even in such a case, the printed layer and the base material layer can be bonded with sufficient adhesive strength.

According to the invention as recited in the aforementioned Item [4], since the amount of the adhesive layer is 1 to 10 g/m², sufficient adhesive strength can be secured while maintaining lightweightness.

According to the invention as recited in the aforementioned Item [5], since the adhesive layer is formed by printing, the productivity can be improved.

According to the invention as recited in the aforementioned Item [6], since the mass ratio of the carboxylic acid denaturation propylene-1-butene copolymer resin/the carboxylic acid denaturation propylene-ethylene-1-butene copolymer resin falls within the range of 60/40 to 90/10, sufficient adhesive strength can be secured even after annealing treatment.

According to the invention as recited in the aforementioned Item [7], as the adhesive for bonding the printed layer formed on the lower surface of the surface resin layer and the olefin series resin base material layer, a mixture in which carboxylic acid denaturation propylene-1-butene copolymer resin/carboxylic acid denaturation propylene-ethylene-1-butene copolymer resin are mixed within the mass ratio range of 55/45 to 95/5 is used. Therefore, even after completion of annealing treatment for inherence strain removal, the printed layer formed on the lower surface of the surface resin layer and the base material layer can be bonded with sufficient adhesive strength.

According to the invention as recited in the aforementioned Item [8], since the annealing treatment temperature is 80 to 120° C. distortion inherent in the flooring material can fully be removed without reducing the adhesive strength.

### BRIEF DESCRIPTION OF THE DRAWINGS

The aforementioned objects and other objects, features and advantages of the present invention will become more apparent from the following description of the preferred embodiment with reference to the attached figure.

The FIGURE is a cross-sectional view showing an embodiment of an olefin series following material according to the present invention.

### DETAILED DESCRIPTION OF THE PREFERRED EMBODIMENTS

An embodiment of an olefin series flooring material according to the present invention will be explained with reference to the attached drawing. The olefin series flooring material 1 of this embodiment has lamination layer structure in which a printed is layer 4 containing synthetic resin is laminated on a lower surface of a surface resin layer 2 containing olefin series resin and a base material layer 3 containing olefin series resin is integrally laminated on a lower surface of the printed layer 4 via an adhesive layer 5 (see the FIGURE).

As the adhesive constituting the adhesive layer 5, adhesive in which carboxylic acid denaturation propylene-1-butene copolymer resin and carboxylic acid denaturation propylene-ethylene-1-butene copolymer resin are contained and a mass ratio of the carboxylic acid denaturation propylene-1-butene copolymer resin/the carboxylic acid denaturation propylene-ethylene-1-butene copolymer resin falls within the range of 55/45 and 95/5 is used.

In this embodiment, the base material layer 3 is two-layer structure in which a shielding resin layer 11 is laminated on the upper surface of the olefin series resin layer 12. That is, the shielding resin layer 11 and the printed layer 4 are integrally bonded with the adhesive layer 5.

Furthermore, in this embodiment, a nonwoven fabric 20 is laminated on the base material layer 3 in an impregnated state. This impregnated nonwoven fabric layer 20 is provided to fully acquire the adhesion with respect to a construction substrate.

In the olefin series flooring material 1 according to the aforementioned structure, as the adhesive 5 for bonding the printed layer 4 formed on the lower surface of the surface resin layer 2 and the olefin series resin base material layer 3, adhesive in which carboxylic acid denaturation propylene-1-butene copolymer resin and carboxylic acid denaturation propylene-ethylene-1-butene copolymer resin are contained and a mass ratio of the carboxylic acid denaturation propylene-1-butene copolymer resin/the carboxylic acid denaturation propylene-ethylene-1-butene copolymer resin falls within the range of 55/45 to 95/5 is used. Therefore, the printed layer 4 formed on the lower surface of the surface resin layer and the base material layer 3 can be bonded with sufficient adhesive strength.

In the present invention, the surface resin layer 2 contains olefin series resin. Since the surface resin layer 2 contains olefin series resin, the flooring material 1 becomes excellent in surface wear resistance and contamination resistance. As the olefin series resin, although it is not specifically limited, polypropylene, polyethylene, ethylene-vinyl acetate copolymer resin, ethylene-α olefine copolymer resin, olefin series thermoplastic elastomer, etc., can be exemplified. This surface resin layer 2 can be single layer structure or multiple layer structure.

Among other things, as the surface resin layer 2, it is preferable to employ lamination layer structure (see the FIGURE) in which the uppermost layer 2a is made of polypropylene, the lowermost layer 2c is made of polypropylene, and the intermediate layer 2b disposed between these layers 2a and 2c is made of olefin series thermoplastic elastomer. Since the uppermost layer 2a and the lowermost layer 2c constituting the surface resin layer 2 are made of resins of the same kind, warping can be sufficiently prevented. Furthermore, since the intermediate layer 2b is made of olefin series thermoplastic elastomer, there is an advantage that sufficient flexibility can be given.

Although the thickness of the surface resin layer 2 is not specifically limited, it is preferable that the thickness is set to 100 to 1,000 μm. Sufficient wear resistance can be obtained when the thickness is 100 μm or more, and generation of downward warping of the flooring material 1 can be effectively prevented when the thickness is 1,000 μm or less.

The base material layer 3 contains olefin series resin. As the olefin series resin, although it is not specifically limited, for example, polypropylene, polyethylene, ethylene-vinyl acetate copolymer resin, ethylene-α olefine-copolymer resin, olefin series thermoplastic elastomer, etc., can be exemplified. This base material layer 3 can be single layer structure or multiple layer structure. At the surface side position of the base material layer 3, a shielding resin layer 11 is preferably formed. By disposing such a shielding resin layer 11 at the rear side of the printed layer 4, the design, pattern, etc., of the printed layer 4 can be clearly visualized in a good contrast. As the shielding resin layer 11, for example, a shielding resin layer made of a composite in which color pigment, antioxidant and ultraviolet absorption agent are mixed in olefin series resin can be exemplified, but not limited to such structure.

Although the thickness of the base material layer 3 is not specifically limited, it is preferably set to 1 to 5 mm. Sufficient dimensional stability can be secured when the thickness is 1 mm or more. Lightweightness as a flooring material 1 can be maintained when the thickness is 5 mm or less, securing good handling ability.

Although the printed layer 4 is not specifically limited, it can be formed by, for example, printing technique, such as, e.g., gravure printing, offset printing, screen printing, transfer printing, or ink-jet printing. As the printing ink used for this printing, although it is not specifically limited, for example, printing ink in which pigment, colorant, coloring agent, bulking agent, etc., are added to and mixed in synthetic resin, such as, e.g., acrylics series resin, urethane series resin, or polyester series resin. Usually, the printing ink is diluted with solvent, etc.

As the adhesive constituting the adhesive layer 5, adhesive containing carboxylic acid denaturation propylene-1-butene copolymer resin and carboxylic acid denaturation propylene-ethylene-1-butene copolymer resin is used. In the adhesive, the mixed mass ratio of both components should be set such that the mass ratio of the carboxylic acid denaturation propylene-1-butene copolymer resin/the carboxylic acid denaturation propylene-ethylene-1-butene copolymer resin falls within the range of 55/45 to 95/5. If the mixed quantity of the carboxylic acid denaturation propylene-ethylene-1-butene copolymer resin is larger than the upper limit value (55/45) of the stipulated range, sufficient adhesive strength cannot be obtained after performing annealing treatment for inherent strain removal. If the mixed quantity of the carboxylic acid denaturation propylene-ethylene-1-butene copolymer resin becomes less than the lower limit (95/5) of the stipulated range, sufficient adhesive strength cannot be obtained before and after annealing treatment. Among other things, it is preferable that the mass ratio of the carboxylic acid denaturation propylene-1-butene copolymer resin/the carboxylic acid denaturation propylene-ethylene-1-butene copolymer resin is set so as to fall within the range of 60/40 to 90/10.

As the carboxylic acid denaturation propylene-1-butene copolymer resin, it is preferable to use maleic acid denaturation propylene-1-butene copolymer resin. In this case, the adhesive strength between the printed layer 4 and the base material layer 3 can be further enhanced. Moreover, as the carboxylic acid denaturation propylene-ethylene-1-butene copolymer resin, it is preferable to use maleic acid denaturation propylene-ethylene-1-butene copolymer resin. In this case, the adhesive strength between the printed layer 4 and the base material layer 3 can be further enhanced. As the carboxylic acid used for the carboxylic acid denaturation, other than maleic acid, for example, acrylic acid, meta-acrylic acid, fumaric acid, crotonic acid, itaconic acid, citraconic acid, maleic anhydride, anhydrous citraconic acid, phthalic anhydride, etc., can be exemplified.

As the carboxylic acid denaturation propylene-1-butene copolymer resin, two-component system copolymer in which carboxylic acid denaturation propylene and 1-butene are copolymerized can be represented, but not limited to such a two-component system. So long as the effects of this invention are not harmed, copolymer resin in which one or a plurality of copolymerization components (except for ethylene) other than carboxylic acid denaturation propylene and 1-butene are copolymerized in addition to carboxylic acid denaturation propylene and 1-butene can also be used.

Moreover, as the carboxylic acid denaturation propylene-ethylene-1-butene copolymer resin, three-component system copolymer in which copolymerization of carboxylic acid denaturation propylene, ethylene and 1-butene are copolymerized can be represented, but not limited to such a three-component system. It is not specifically limited to such a three-component system. So long as the effects of this invention are not harmed, copolymer resin in which one or a plurality of copolymerization components other than carboxylic acid denaturation propylene, ethylene, 1-butene are copolymereized in addition to carboxylic acid denaturation propylene, ethylene, 1-butene can also be used.

The amount (weight per unit area) of the adhesive layer 5 is preferably set to 1 to 10 g/m² (solid content). Sufficient adhesive strength can be secured when it is 1 g/m² or more, and lightweightness can be maintained when it is 10 g/m² or less.

Among other things, the amount of the adhesive layer 5 is preferably set to 2 to 5 g/m² (solid content).

Although the formation technique of the adhesive layer 5 is not specifically limited, for example, a printing method, a dry laminating method, a wet laminating method, etc., can be exemplified.

To any one of the surface resin layer 2, the base material layer 3 and the adhesive layer 5, various additives, such as, e.g., antioxidant, ultraviolet absorption agent, lubricant, stabilizer, light stabilizer, flame retarder, colorant, antistatic agent, or bulking agent, can be added arbitrarily.

Although the thickness of the olefin series flooring material 1 of the present invention is not specifically limited, the thickness is usually 2 to 5 mm. Moreover, it can be constituted as a tile-like flooring material or a sheet-like flooring materials (for example, a long sheet with a width of about 600 to 2,500 mm, etc.), but not limited thereto.

The olefin series flooring material 1 having the aforementioned structure can be manufactured, for example, as follows. Initially, a printed layer 4 is formed by printing with printing ink containing synthetic resin on the lower surface of the surface resin sheet (surface resin layer) 2 containing olefin series resin. As the printing ink, ink in which pigment is mixed in urethane series resin is used for example.

Next, a mixed resin composite in which carboxylic acid denaturation propylene-1-butene copolymer resin/carboxylic acid denaturation propylene-ethylene-1-butene copolymer resin are mixed in a mass ratio of 55/45 to 95/5 is applied to the lower surface of the printed layer 4. This mixed resin composite is diluted with organic solvents, such as, e.g., toluene, methyl ethyl ketone, isopropyl alcohol, ethanol, or xylene, and is usually applied in a state of solution. The application technique is not specifically limited, and a printing method, a dry laminating method, a wet laminating method, etc., can be exemplified.

Thereafter, a base material sheet (base material layer) 3 containing olefin series resin is superimposed on the applied surface of the printed layer 4 and bonded to thereby obtain a laminated member. Usually, they are bonded by heating under pressure.

Then, the laminated member is subjected to annealing treatment by heating. By executing such annealing treatment, distortion inherently existing in the flooring material 1 can fully be removed. The heating temperature is preferably set to 80 to 120° C. The heating time (annealing treatment time) is preferably set to 2 to 48 hours.

The flooring material 1 according to the present invention is not limited to the flooring material manufactured by the above explained manufacturing method.

Next, concrete examples of this invention will be explained.

### Example 1

A composite containing amorphous propylene-ethylene copolymer: 60 mass portion, polypropylene: 40 mass portion, calcium carbonate: 300 mass portion, lubricant: 2 mass portion were mixed with a Bambury mixer, and a base material sheet (base material layer) with a thickness of 1.6 mm was formed using a calender molding machine. On one side of this base material sheet, a polypropylene spunbonded nonwoven fabric of weight per unit area of 40 g/m² is superimposed and heat-pressed at 150° C. to thereby integrally laminate the spunbonded nonwoven fabric to the base material sheet in an impregnated state.

On the other hand, a surface resin sheet (surface resin layer) with a thickness of 300 μm having three layer structure of uppermost layer/intermediate layer/lowermost layer=polypropylene resin layer/olefin series thermoplastic elastomer layer/polypropylene resin layer was formed using a coextruder. The rear surface of this surface resin sheet was subjected to corona treatment, and a printed layer was formed by giving a prescribed pattern on the corona-treated surface by carrying out gravure printing using ink in which pigment was added to urethane series resin.

Next, on the lower surface of the printed layer, adhesive liquid containing maleic acid denaturation propylene-1-butene copolymer resin: 60 mass portion, maleic acid denaturation propylene-ethylene-1-butene copolymer resin: 40 mass portion, toluene: 450 mass portion, methyl-ethyl-ketone: 30 mass portion, isopropyl alcohol: 5 mass portion was applied by a gravure method. Thereafter, the base material sheet was superimposed on the adhesive liquid applied surface and press-bonded at 150° C. to thereby obtain a laminated member. The obtained laminated member was subjected to annealing treatment by heating at 100° C. for 24 hours. The resulting flooring material shown in the FIGURE was obtained. The amount of adhesive in this flooring material was 3 g/m².

### Examples 2-4, Comparative Examples 1-7

Flooring materials were obtained in the same manner as in Example 1 except that the mixed mass ratio of the resin component (two components) in the adhesive liquid was set to the ratio shown in Table 1 (other components being contained by the same mass portion).

TABLE 1

| | | Comparative Example | | | | | | Example | | | | Comparative |
|---|---|---|---|---|---|---|---|---|---|---|---|---|
| | | 1 | 2 | 3 | 4 | 5 | 6 | 1 | 2 | 3 | 4 | Example 7 |
| Composition | A component | — | 10 | 20 | 30 | 40 | 50 | 60 | 70 | 80 | 90 | 100 |
| | B component | 100 | 90 | 80 | 70 | 60 | 50 | 40 | 30 | 20 | 10 | — |
| Peel strength | Before | 32.5 | 33.0 | 29.0 | 24.0 | 40.5 | 41.0 | 35.5 | 33.5 | 31.5 | 29.5 | 25.5 |
| (N/inch) | annealing | | | | | | | | | | | |
| | After | 19.0 | 22.0 | 14.0 | 13.0 | 18.0 | 17.0 | 29.5 | 33.5 | 37.0 | 35.0 | 26.0 |
| | annealing | | | | | | | | | | | |

A component: Maleic acid denaturation propylene-1-butene copolymer resin
B component: Maleic acid denaturation propylene-ethylene-1-butene copolymer resin

Each of the flooring material obtained as mentioned above was subjected to the following test. The test results are shown in Table 1.

<Peel Strength Testing Method>

The peel strength between the printed layer and the base material layer of each laminated member before performing the 100° C.—24 hour—annealing treatment was measured in accordance with JIS K6854. Moreover, as to the flooring material (product) after performing the 100° C.—24 hour—annealing treatment, the peel strength between the printed layer and the base material layer was also measured in accordance with JIS K6854.

As will be clear from Table 1, in the olefin series flooring materials of Examples 1 to 4 of the present invention, they were integrally bonded with sufficient adhesive strength even after the annealing treatment for inherent strain removal like before the annealing treatment. In contrast, in the olefin series flooring material of Comparative Examples 1 to 6, the adhesion strength after the annealing treatment was deteriorated notably. Moreover, in the olefin series flooring material of Comparative Example 7, sufficient adhesive strength could not be obtained before and after the annealing treatment.

The language and explanation herein are used for explaining embodiments of the present invention, and the present invention is not limited to them. The present invention allows any design modifications so long as it is within the scope of the claims unless it deviates the spirits of the present invention.

What is claimed is:

1. An olefin series flooring material, comprising:
a surface resin layer containing olefin series resin;
a printed layer laminated on a lower surface of the surface resin layer; and
a base material layer containing olefin series resin integrally laminated on a lower surface of the printed layer via an adhesive layer,
wherein the adhesive layer contains carboxylic acid denaturation propylene-1-butene copolymer resin and carboxylic acid denaturation propylene-ethylene-1-butene copolymer resin, and
wherein a mass ratio of the carboxylic acid denaturation propylene-1-butene copolymer resin/the carboxylic acid denaturation propylene-ethylene-1-butene copolymer resin falls within the range of 55/45 to 95/5.

2. The olefin series flooring material as recited in claim 1, wherein maleic acid denaturation propylene-1-butene copolymer resin is used as the carboxylic acid denaturation propylene-1-butene copolymer resin, and wherein maleic acid denaturation propylene-ethylene-1-butene copolymer resin is used as the carboxylic add denaturation propylene-ethylene-1-butene copolymer resin.

3. The olefin series flooring material as recited in claim 1, wherein the printed layer contains urethane series resin.

4. The olefin series flooring material as recited in claim 1, wherein an amount of the adhesive layer is 1 to 10 g/m².

5. The olefin series flooring material as recited in claim 1, wherein the adhesive layer is formed by printing.

6. The olefin series flooring material as recited in claim 1, wherein a mass ratio of the carboxylic acid denaturation propylene-1-butene copolymer resin/the carboxylic acid denaturation propylene-ethylene-1-butene copolymer resin falls within the range of 60/40 to 90/10.

7. The olefin series flooring material as recited in claim 1, wherein a thickness of the surface resin layer is 100 to 1,000 μm, and wherein a thickness of the base material layer is 1 to 5 mm.

8. An olefin series flooring material, comprising:
a surface resin layer containing olefin series resin;
a printed layer containing urethane series resin laminated on a lower surface of the surface resin layer; and
a base material layer containing olefin series resin integrally laminated on a lower surface of the printed layer via an adhesive layer,
wherein the adhesive layer contains carboxylic acid denaturation propylene-1-butene copolymer resin and carboxylic acid denaturation propylene-ethylene-1-butene copolymer resin, and
wherein a mass ratio of the carboxylic acid denaturation propylene-1-butene copolymer resin/the carboxylic acid denaturation propylene-ethylene-1-butene copolymer resin falls within the range of 55/45 to 95/5,
wherein an amount of the adhesive layer is 1 to 10 g/m², the adhesive layer being formed by printing, and
wherein a thickness of the surface resin layer is 100 to 1,000 μm, and a thickness of the base material layer is 1 to 5 mm.

9. A method of manufacturing an olefin series flooring material, comprising:
a step of forming a printed layer on a lower surface of a surface resin layer containing olefin series resin by printing using printing ink containing synthetic resin;
a step of applying a mixture in which carboxylic acid denaturation propylene-1-butene copolymer resin/carboxylic acid denaturation propylene-ethylene-1-butene copolymer resin are mixed in a mass ratio of 55/45 to 95/5 on a lower surface of the printed layer;
a step of superimposing a base material layer containing olefin series resin on a mixture applied surface of the printed layer and bonding them to thereby obtain a laminated member; and
a step of heating the laminated member.

10. The method of manufacturing an olefin series flooring material as recited in claim 9, wherein the laminated member is heated at a temperature of 80 to 120° C.
